(19) United States
(12) Patent Application Publication
(10) Pub. No.: US 2013/0174083 A1
(43) Pub. Date: Jul. 4, 2013

(54) ELECTRONIC DEVICE AND METHOD OF CONTROLLING THE SAME

(71) Applicant: Acer Incorporated, Taipei Hsien (TW)

(72) Inventors: Kuei-Ping TING, Taipei Hsien (TW); Chao-Kuang YANG, Taipei Hsien (TW)

(73) Assignee: Acer Incorporated, Taipei Hsien (TW)

(21) Appl. No.: 13/673,232

(22) Filed: Nov. 9, 2012

(30) Foreign Application Priority Data
Dec. 28, 2011 (TW) 100149115

(51) Int. Cl. G06F 3/0488

(52) U.S. Cl. CPC G06F 3/0488
USPC 715/781

(57) ABSTRACT

Methods for controlling electronic devices are provided. First and second objects corresponding to unlock operation are displayed on a touch screen of an electronic device. When contact with the touch screen is detected under a user-interface lock state, it is determined whether a continuous moving path corresponding to the detected contact has passed through the first object, and whether moving acceleration of the contact has exceeded a preset value. If so, the first object is shown as cutting through and being separated by the continuous moving path into a first stationary part and a first dissociated part. The first stationary part and the first dissociated part are displayed as separated parts, and the first dissociated part moves with the second object connected thereto according to pre-determined physical principles. The electronic device switches from the user-interface lock state to a work state.

### CROSS REFERENCE TO RELATED APPLICATIONS

This application claims priority of Taiwan Patent Application Ser. No. 100149115, filed 2011 Dec. 28, entitled ELECTRONIC DEVICE AND METHOD OF CONTROLLING THE SAME. The contents of this application are hereby incorporated by reference.

### BACKGROUND OF THE INVENTION

1. Field of the Invention

The disclosure relates generally to electronic devices and a method of controlling the same and, more particularly, to unlocking of user interfaces on portable electronic devices by inputting preset gestures.

2. Description of the Related Art

Recently, electronic devices, such as handheld devices, have become more and more technically advanced and multifunctional. Due to increased convenience and functions of the devices, these devices have become necessities of life.

Touch screens are becoming more popular for use both as displays and as user input devices, especially for use with portable devices. Users may interact with the devices through the touch screens. Such devices lock the touch screen after a certain period of idleness. A user has to unlock the device before it is used again.

Devices may be unlocked by any of several well-known unlocking procedures, such as entering a password or conducting gestures (such as a sliding motion or pressing a button or a combination of buttons) on the touch screen following a prompt which is displayed on the touch screen. A function can be activated only after the unlocking procedure has been performed and the device has been switched to an unlocked state. For these unlocking procedures, the memorization of passwords can be burdensome and pressing a combination of buttons may be hard to perform. As a consequence, these drawbacks may reduce the ease of using such devices.

Accordingly, there is a need for more user-friendly procedures for unlocking such devices, and a method enabling users to directly activate applications of such devices under a locked state.

### BRIEF SUMMARY OF THE INVENTION

A method of controlling an electronic device with a touch-sensitive screen and an electronic device are provided.

In an embodiment of a method of controlling an electronic device with a touch-sensitive screen, a first object and a second object corresponding to an unlock operation are displayed on the touch-sensitive screen. The first object links to an edge of a display of the touch-sensitive screen, and the second object links to the first object, rather than linking to any edge of the display. While the electronic device is in a user-interface lock state, a contact with the touch-sensitive screen is detected. In response to the detected contact on the touch-sensitive screen, it is determined whether a continuous moving path corresponding to the contact has passed through the first object, and it is also determined whether moving acceleration of the contact has exceeded a preset value. When the continuous moving path corresponding to the contact has passed through the first object, and the moving acceleration of the contact has exceeded the preset value, the displayed first object as being separated from a first stationary part and a first disassociated part, wherein the first stationary part is linked to the edge of the display, and the first disassociated part is linked to the second object, and the first disassociated part is displayed as being severed from the first stationary part and moving away, along with the second object, from the first stationary part according to pre-determined physical principles. The electronic device then switches from the user-interface lock state into a work state.

According to an embodiment, when the continuous moving path corresponding to the contact has passed through the first object, and the moving acceleration of the contact has not exceeded the preset value, the first object and the second object are displayed as moving according to the pre-determined physical principles, and the first object is displayed as not being separated from the continuous moving path.

According to an embodiment, the edge linked to the first object is an upper edge of the display, and the first object is a piece of string, wherein the second object is a hanging object (such as a pendulum) suspended from the piece of string. When the continuous moving path corresponding to the contact has passed through the piece of string, and the moving acceleration of the contact has exceeded the preset value, the piece of string as being cut off by the continuous moving path, and the first disassociated part of the piece of string is severed from the first stationary part, and the first disassociated part and the hanging object moves away from the first stationary part according to pre-determined physical principles.

According to an embodiment, the edge linked to the first object as a lower edge of the display, and the first object is a piece of string, wherein the second object is a floating object (such as a balloon) fastened to the piece of string. When the continuous moving path corresponding to the contact has passed through the piece of string, and the moving acceleration of the contact has exceeded the preset value, the piece of string as being cut off by the continuous moving path, and the first disassociated part of the piece of string is severed from first stationary part, and the first disassociated part and the floating object moves away from the first stationary part according to pre-determined physical principles.

According to an embodiment, in addition to the first and second objects, a third object and a fourth object corresponding to initiation of an operation for an application program are displayed on the touch-sensitive screen, wherein the third object links to a stationary object, and the fourth object links to the third object, rather than linking to the stationary object or any edge of the display, and Y coordinates on the vertical direction of the display, of the third object, do not overlap with the Y coordinates of the first object. It is determined whether the continuous moving path corresponding to the contact has passed through the third object, and whether the moving acceleration of the contact has exceeded the preset value. When the continuous moving path corresponding to the contact has passed through the third object, and the moving acceleration of the contact has exceeded the preset value, the displayed third object as being separated from a third stationary part and a third disassociated part, wherein the third stationary part is linked to the stationary object, and the third disassociated part is linked to the fourth object, and the third disassociated part is displayed as being severed from the third stationary part and moving away, along with the fourth object, from the third stationary part according to pre-determined physical principles. The electronic device then switches from the user-interface lock state into an execution state for operation of the application program.

An embodiment of an electronic device includes a touch-sensitive screen and a controller. The touch-sensitive screen comprises a display and receives contact inputs, wherein the display displays a first object and a second object corresponding to an unlock operation. The first object links to an edge of the display, and the second object links to the first object, rather than linking to any edge of the display. The controller detects a contact with the touch-sensitive screen, while the electronic device is in the user-interface lock state. In response to the detected contact on the touch-sensitive screen, the controller determines whether a continuous moving path corresponding to the contact has passed through the first object, and whether moving acceleration of the contact has exceeded a preset value. When the continuous moving path corresponding to the contact has passed through the first object, and the moving acceleration of the contact has exceeded the preset value, the controller causes the touch-sensitive screen to separate the displayed first object into a first stationary part and a first disassociated part. The first stationary part is linked to the edge, and the first disassociated part is linked to the second object. The first disassociated part is displayed as being severed from the first stationary part and moving away, along with the second object, from the first stationary part according to pre-determined physical principles. The controller causes the electronic device to switch from the user-interface lock state into a work state.

Methods of controlling an electronic device with a touch-sensitive screen, and related operating systems may take the form of a program code embodied in a tangible media. When the program code is loaded into and executed by a machine, the machine becomes a device for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an electronic device of the invention;

FIG. 2 is a flowchart of a first embodiment of a method of controlling an electronic device with a touch-sensitive screen;

FIGS. 3A˜3F illustrate displays of an electronic device according to embodiments of the invention;

FIGS. 4A˜4D illustrate displays of an electronic device according to embodiments of the invention;

FIGS. 5A˜5C are flowcharts of a second embodiment of a method of controlling an electronic device with a touch-sensitive screen;

FIGS. 6A˜6C illustrate displays of an electronic device according to embodiments of the invention; and

FIGS. 7A˜7C illustrate displays of an electronic device according to embodiments of the invention.

### DETAILED DESCRIPTION OF THE INVENTION

Methods of controlling an electronic device with a touch-sensitive screen and electronic device are provided.

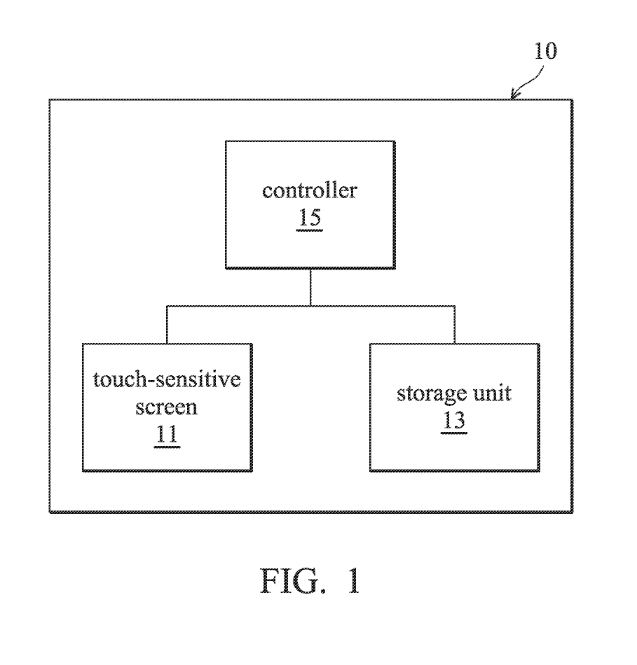

FIG. 1 is a schematic diagram illustrating an embodiment of an electronic device of the invention. According to an embodiment, an electronic device 10 can be a personal computer or portable electronic device, such as a PDA (Personal Digital Assistant), a mobile phone, a smart phone, or a mobile Internet Device (MID).

The electronic device 10 comprises a touch-sensitive screen 11, a storage unit 13, and a controller 15.

The touch-sensitive screen 11 has a touch-sensitive surface. The touch-sensitive screen 11 can detect contact and movement of a control tool, such as a stylus or finger(s) on the touch-sensitive surface. The touch-sensitive screen 11 can display related graphics, data, and interfaces. The touch-sensitive screen 11 receives inputs corresponding to user manipulation, and transmits the received input to the controller 15 for further processing.

The storage unit 13 stores user data, settings and software of the electronic device 10.

The controller 15 executes a method of controlling an electronic device with a touch-sensitive screen of the invention. Related details are discussed later.

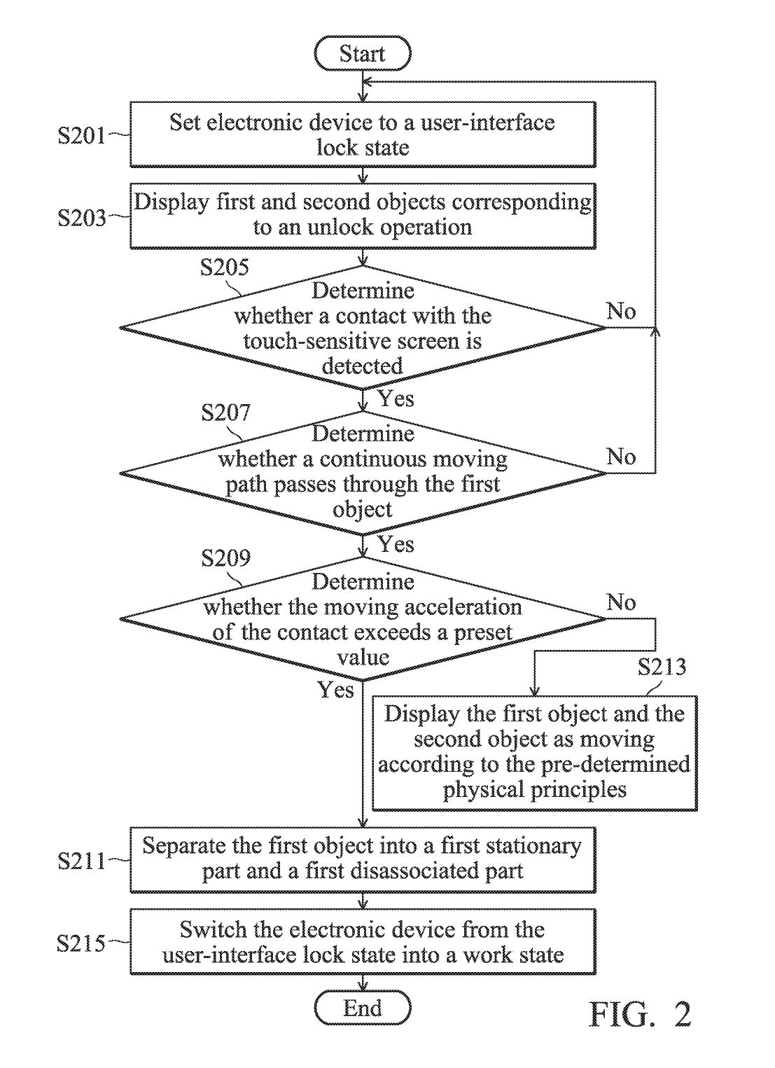

FIG. 2 is a flowchart of an embodiment of a method of controlling an electronic device with a touch-sensitive screen. The method of controlling an electronic device with a touch-sensitive screen can be used in an electronic device, including but not limited to a PDA (Personal Digital Assistant), a smart phone, a mobile phone, or the like. According to an embodiment, the electronic device is equipped with a touch-sensitive screen.

In step S201, the electronic device 10 is set to a user-interface lock state.

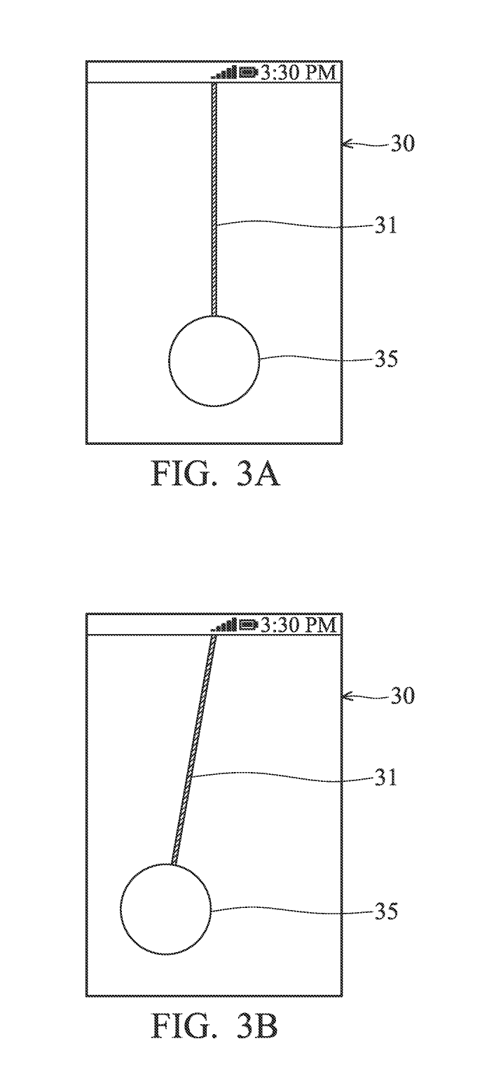

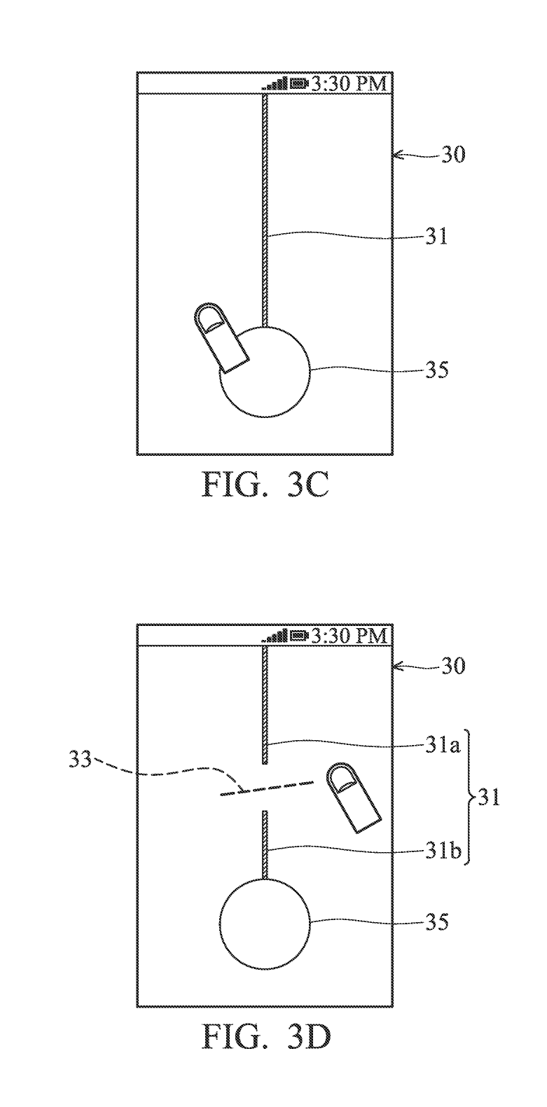

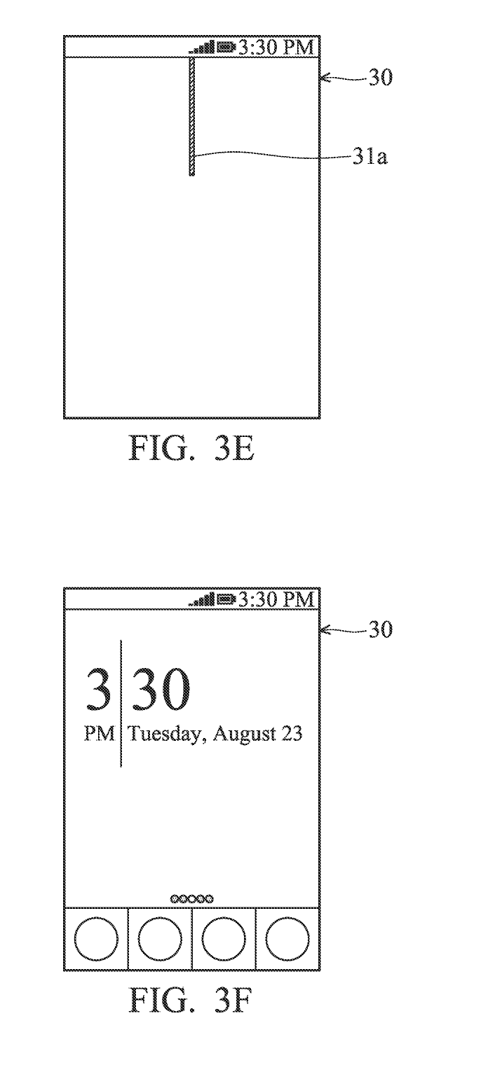

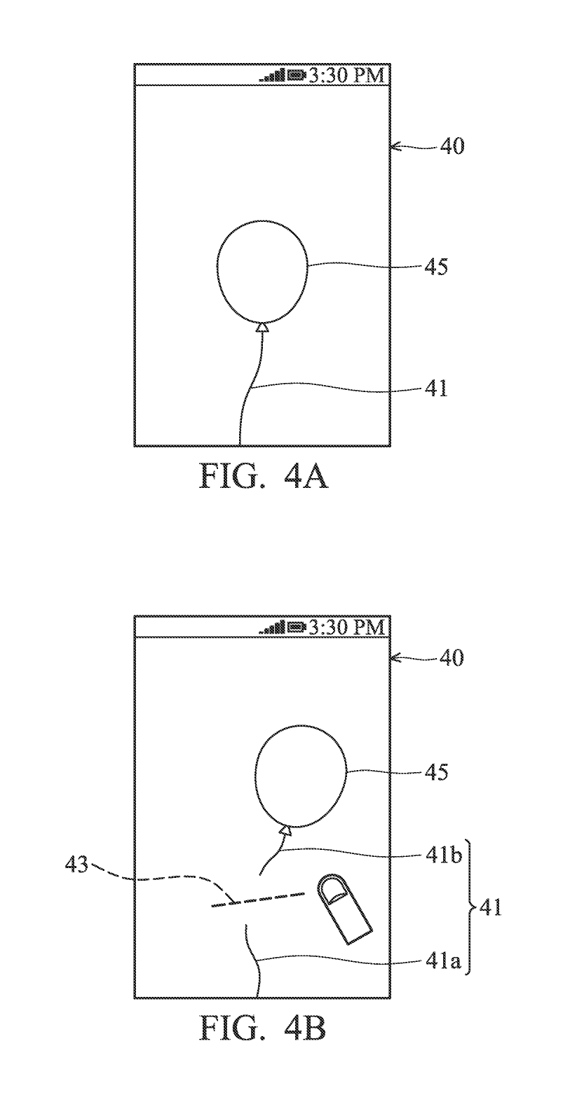

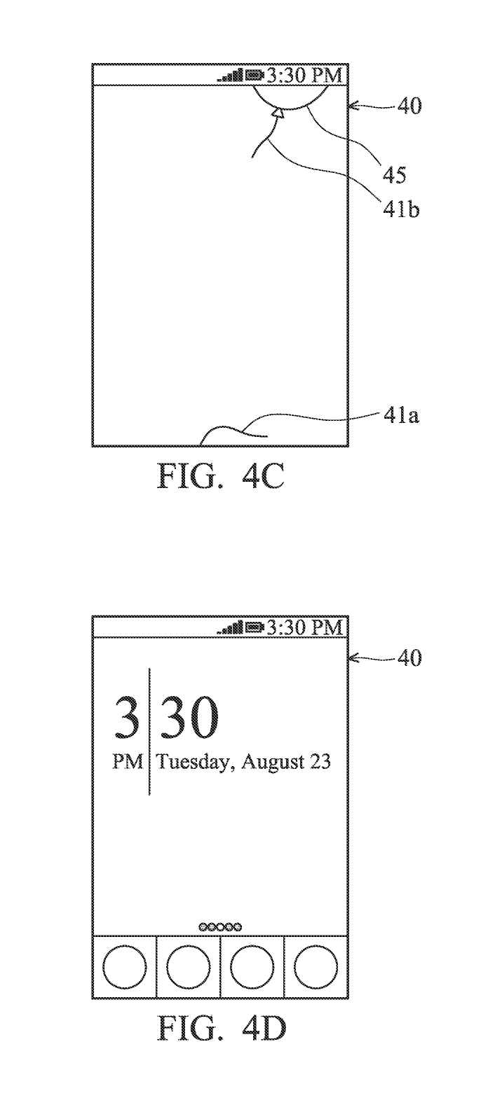

In step S203, when the electronic device is in the user-interface lock state, a first object and a second object corresponding to an unlock operation are displayed on the touch-sensitive screen. The first object links to an edge of a display of the touch-sensitive screen, and the second object links to the first object, rather than linking to any edge of the display. The first and second objects can be designed in a variety of ways to meet requirements. For example, the first object is designed as a piece of string, wherein the second object is a hanging object (such as a pendulum) suspended from the piece of string (as shown in FIGS. 3A˜3F) or the first object can be designed as a piece of string, wherein the second object is a floating object (such as a balloon) fastened to the piece of string (as shown in FIGS. 4A˜4E).

In step S205, it is determined whether a contact with the touch-sensitive screen is detected, and if so, step S207 is performed; otherwise, step S201 is performed again, setting the electronic device to the user-interface lock state.

In step S207, in response to the detected contact on the touch-sensitive screen, it is determined whether a continuous moving path corresponding to the contact has passed through the first object, and if so, step S209 is performed; otherwise, step S201 is performed again, setting the electronic device to the user-interface lock state.

In step S209, it is determined whether the moving acceleration of the contact has exceeded a preset value, and if so, step S211 is performed; otherwise, step S213 is performed.

In step S211, when the continuous moving path corresponding to the contact has passed through the first object, and the moving acceleration of the contact has exceeded the preset value, the displayed first object is separated into a first stationary part and a first disassociated part. The first stationary part is linked to the edge, and the first disassociated part is linked to the second object, and the first disassociated part is displayed as being severed from the first stationary part and moving away, along with the second object, from the first stationary part according to pre-determined physical principles.

After the step S211, step S215 is performed to switch the electronic device from the user-interface lock state into a work state. In the work state (user-interface unlock state), a user can initiate an application in the electronic device to make a phone call, to establish a connection to the Internet, and the like.

In step S213, when the continuous moving path corresponding to the contact has passed through the first object, and the moving acceleration of the contact has not exceeded the preset value, the first object and the second object are displayed as moving according to the pre-determined physical principles.

Referring to FIGS. 3A˜3F, in the exemplary first embodiment, the electronic device is a mobile phone, and the first object is a piece of string, wherein the second object is a hanging object (such as a pendulum) suspended from the piece of string.

Referring to FIG. 3A, when the display of the mobile phone is activated under a user-interface lock state, a piece of string 31 (first object) and pendulum 35 (second object) hanging from the piece of string 31 are displayed.

In this embodiment, the mobile phone is equipped with a G-sensor. While the mobile phone is in a user-interface lock state, the piece of string 31 and the pendulum 35 are displayed according to outputs of the G sensor. The piece of string 31 is displayed as being attached to an upper edge of the display, and the pendulum 35 is displayed as hanging downward from the piece of string 31 due to gravity. In addition, the piece of string 31 and the pendulum 35 swing according to pre-determined physical principles (as shown in FIG. 3B).

Referring to FIGS. 3C and 3D, a user uses a finger(s) or other means to make a contact and make a continuous moving path 33 on the touch-sensitive screen. If the continuous moving path 33 has passed through the piece of string 31, and moving acceleration of the contact has exceeded a preset value, the piece of string 31 is separated, by the continuous moving path 33 (shown as a dotted line), into two parts: a stationary part 31a and a disassociated part 31b. The stationary part 31a is displayed as being attached to the upper edge of the display 30 and the disassociated part 31b is displayed as being linked to the pendulum 35. On the display 30, the stationary part 31a and the disassociated part 31b are separated, wherein the stationary part 31a swings according to the pre-determined physical principles, and the disassociated part 31b, together with the pendulum 35, depart and fall down.

Referring to FIGS. 3E and 3F, when the pendulum 35 is displayed as falling downward and moving beyond the display range of the display 30, the mobile phone switches from the user-interface lock state into a work state.

In addition, if the continuous moving path 33 has passed through string 31, but the moving acceleration of the contact has not exceeded the preset value, the piece of string 31 is displayed as moving, together with the pendulum 35, according to the pre-determined physical principles, without being cut off by the continuous moving path 33.

In this embodiment, the moving acceleration of the contact is taken into account, in order to avoid an unlocking operation by accidental contact with the touch-sensitive screen. Using this embodiment, the display of the piece of string remains intact unless the user makes a moving contact through the piece of string 31 with enough acceleration.

Referring to FIGS. 4A˜4D, in another exemplary embodiment, the electronic device is a mobile phone, and the first object is a piece of string, wherein the second object is a floating object (such as a balloon) fastened to the piece of string.

As shown in FIG. 4A, while the mobile phone is in a user-interface lock state, a piece of string 41 (first object) and a balloon 45 (second object) fastened to the piece of string 41 are displayed on the display 40.

According to this embodiment, the mobile phone is equipped with a G-sensor. While the mobile phone is in a user-interface lock state, the piece of string 41 and the balloon 45 are displayed according to outputs of the G-sensor. The piece of string 41 is attached to a lower edge of the display, and the balloon 45 is displayed as floating upward from the piece of string 31 by buoyancy.

As shown in FIG. 4B, a user uses a finger(s) or other means to make a contact and make a continuous moving path 43 on the touch-sensitive screen. If the continuous moving path 43 has passed through the piece of string 41, and moving acceleration of the contact has exceeded a preset value, the piece of string 41 is separated, by the continuous moving path 43 (shown as a dotted line), into two parts: a stationary part 41a and a disassociated part 41b. The stationary part 41a is displayed as being attached to the lower edge of the display 40 and the disassociated part 41b is displayed as being linked to the balloon 45. On the display 40, the stationary part 41a and the disassociated part 41b are separated, wherein the disassociated part 41b, together with the balloon 45, are displayed as being detached and floating away.

Referring to FIGS. 4C and 4D, when the balloon 45 is displayed as floating away and moving beyond the display range of the display 40 (as shown in FIG. 4C), the mobile phone switches from the user-interface lock state into a work state (as shown in FIG. 4D).

Similarly, if the continuous moving path 43 has passed through string 41, but the moving acceleration of the contact has not exceeded the preset value, the piece of string 41 is displayed as moving, together with the balloon 45, according to the pre-determined physical principles, without being cut off by the continuous moving path 43.

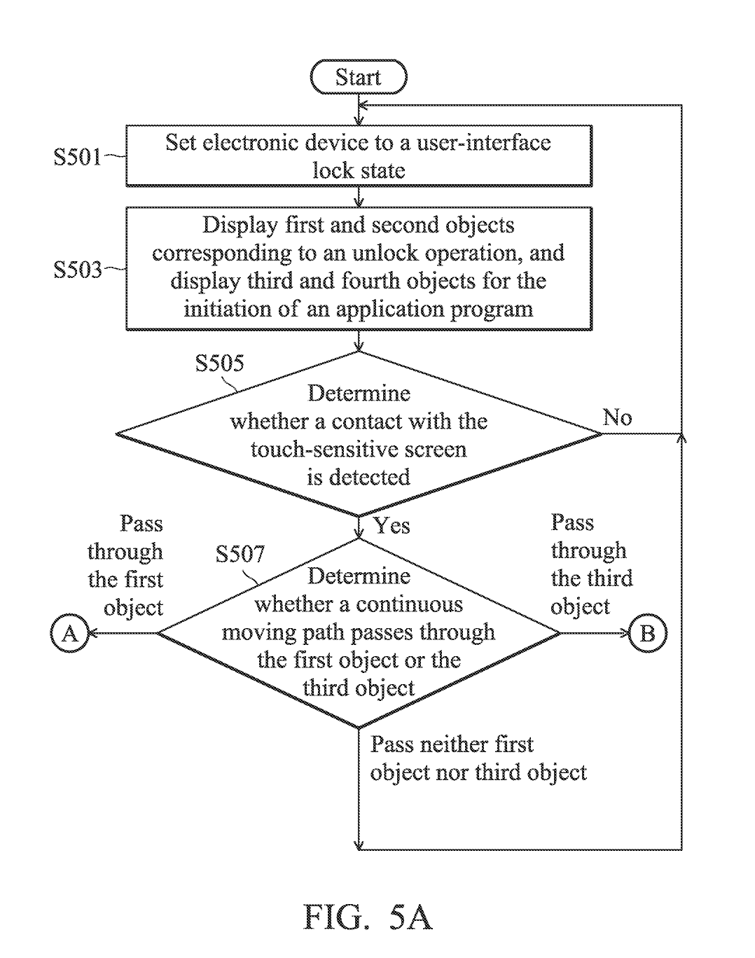

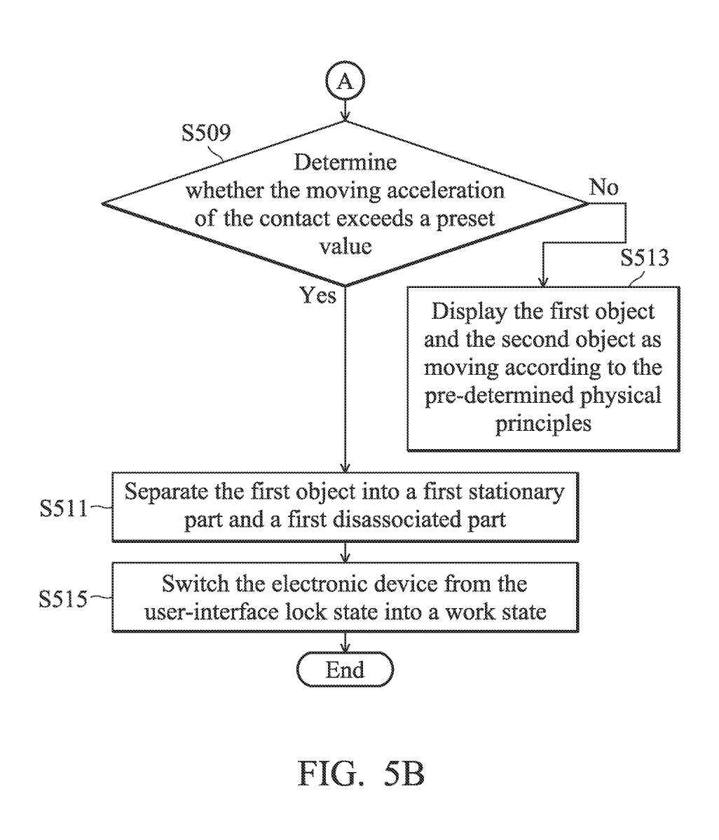

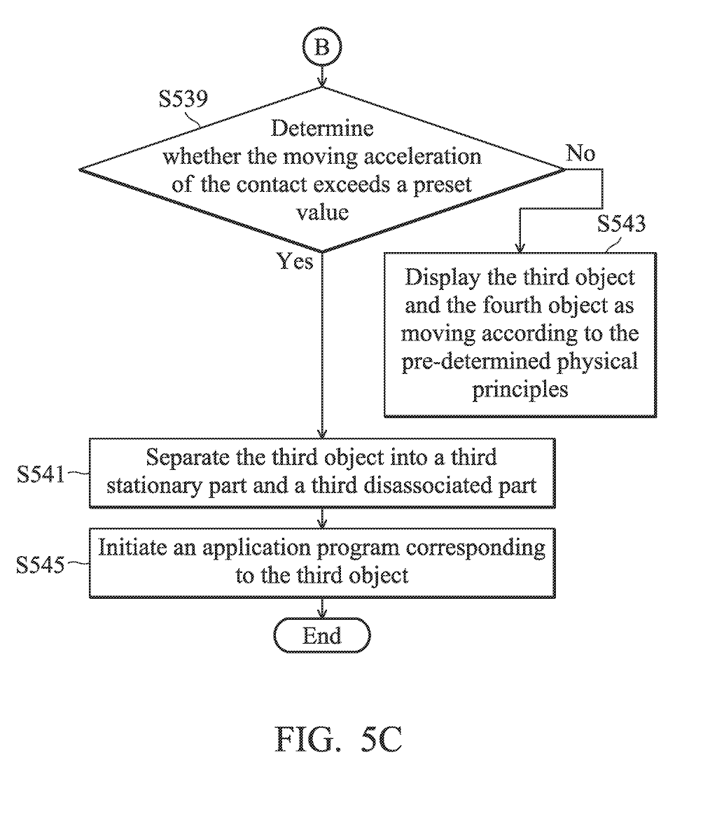

FIGS. 5A˜5C are flowcharts of a second embodiment of a method of controlling an electronic device with a touch-sensitive screen. In the first embodiment, a pair of objects (first and second objects) for an unlock operation is presented on the display screen. In the second embodiment, another pair of objects for the initiation of an application program, as well as the first and second objects for the unlock operation, are displayed on the display screen. The number of objects for the initiation of an application program(s) can be designed to meet requirements, wherein each pair of objects corresponds to the initiation of a particular application program. Here, objects for the unlock operation and a pair of objects for the initiation of an application program are taken as examples.

In step S501, the electronic device 10 is set to a user-interface lock state.

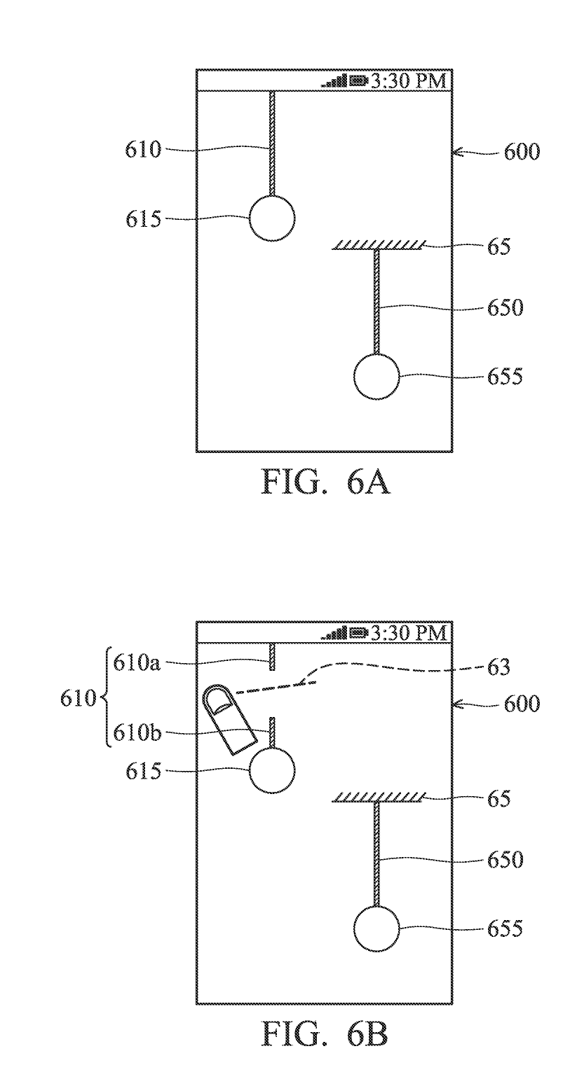

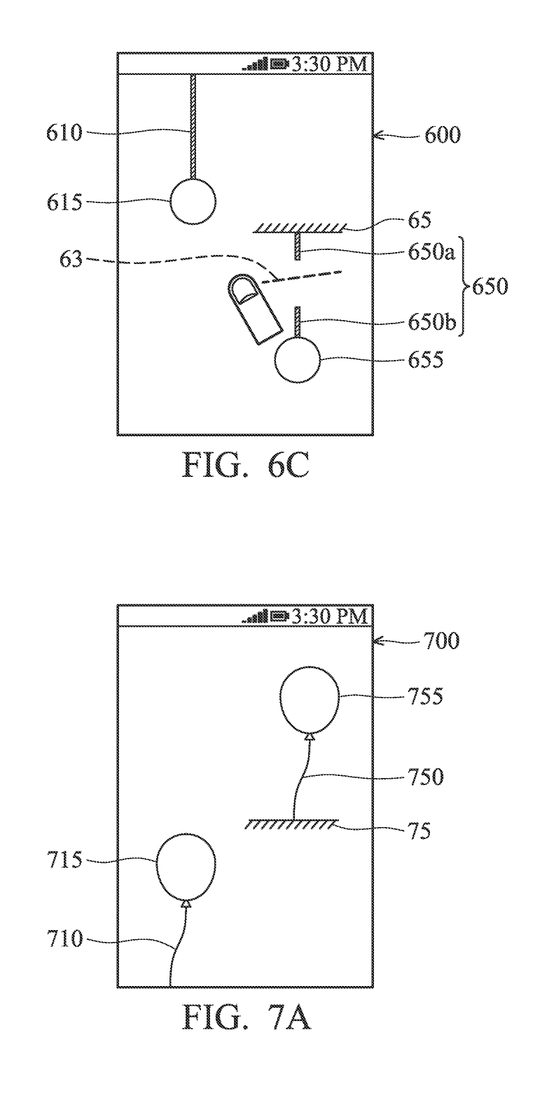

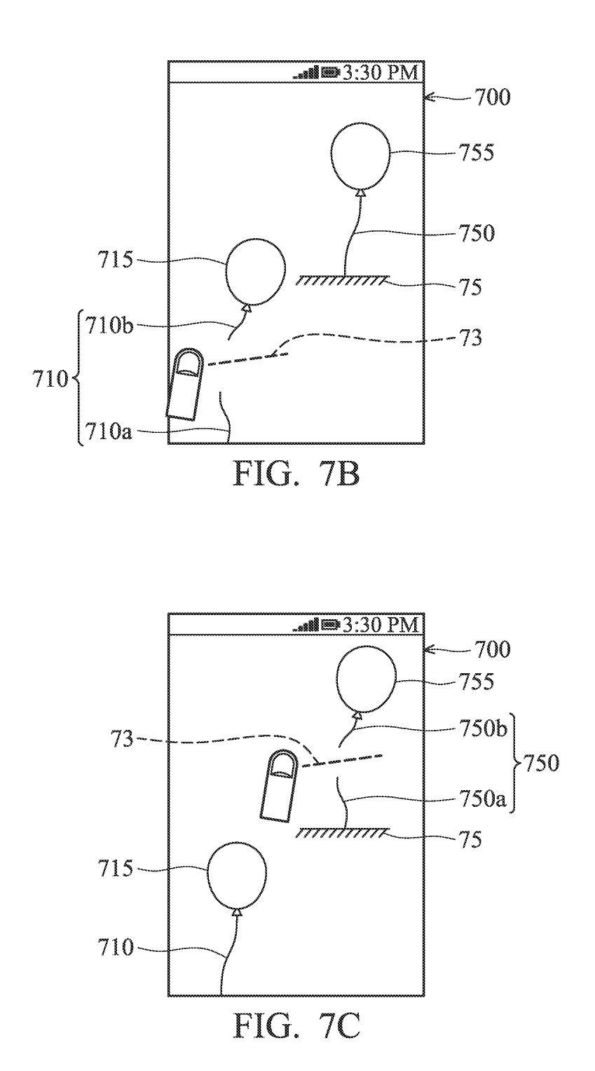

In step S503, when the electronic device is in the user-interface lock state, a first object and a second object corresponding to an unlock operation are displayed on the touch-sensitive screen. In addition, a third object and fourth object for the initiation of an application program are displayed on the touch-sensitive screen. The first and second objects in the second embodiment and the first and second objects in the first embodiment are counterparts in arrangement and function. The third object links to a stationary base, and the fourth object links to the third object, rather than linking to the stationary base or any edge of the display. In addition, on the vertical direction of the display, Y coordinates of the third object, do not overlap with the Y coordinates of the first object (as shown in FIG. 6A and FIG. 7A).

In step S505, it is determined whether a contact with the touch-sensitive screen is detected, and if so, step S507 is performed; otherwise step S501 is performed again, setting the electronic device to the user-interface lock state.

In step S507, in response to the detected contact on the touch-sensitive screen, it is determined whether a continuous moving path corresponding to the contact has passed through the first object or the third object, and if the continuous moving path has passed through the first object, A is processed, and if the continuous moving path has passed through the third object, B is processed, and if the continuous moving path has not passed through the first object or the third object, step S501 is performed again, setting the electronic device to the user-interface lock state.

In step S509, it is determined whether the moving acceleration of the contact has exceeded a preset value, and if so, step S511 is performed; otherwise, step S513 is performed.

In step S511, when the continuous moving path has passed through the first object, and the moving acceleration of the contact has exceeded the preset value, the displayed first object is separated into a first stationary part and a first disassociated part. The first stationary part is linked to the edge, and the first disassociated part is linked to the second object, and the first disassociated part is displayed as being severed from the first stationary part and moving away, along with the second object, from the first stationary part according to pre-determined physical principles.

After the step S511, step S515 is performed to switch the electronic device from the user-interface lock state into a work state.

In step S513, when the continuous moving path corresponding to the contact has passed through the first object, and the moving acceleration of the contact has not exceeded the preset value, the first object and the second object are displayed as moving according to the pre-determined physical principles.

In step S539, it is determined whether the moving acceleration of the contact has exceeded a preset value, and if so, step S541 is performed; otherwise, step S543 is performed.

In step S541, when the continuous moving path has passed through the third object, and the moving acceleration of the contact has exceeded the preset value, the displayed third object is separated into a third stationary part and a third disassociated part. The third stationary part is linked to the stationary base, the third disassociated part is linked to the fourth object, and the third disassociated part is displayed as being severed from the third stationary part and moving away, along with the fourth object, from the third stationary part according to pre-determined physical principles.

After the step S541, step S545 is performed to initiate an application program corresponding to the third object.

In step S543, when the continuous moving path corresponding to the contact has passed through the third object, and the moving acceleration of the contact has not exceeded the preset value, the third object and the fourth object are displayed as moving according to the pre-determined physical principles.

Referring to FIGS. 6A˜6C, in the exemplary second embodiment, the electronic device is a mobile phone, and the first object and third object are pieces of string, and the second object and fourth object are hanging objects (such as a pendulum) suspended from the pieces of string.

Referring to FIG. 6A, while the display of the mobile phone is activated under a user-interface lock state, a piece of string 610 (first object) and pendulum 615 (second object) hanging from the piece of string 610 are displayed on display screen 600. In addition, the piece of string 650 linking to a stationary base 65 and a pendulum 655 hanging from the piece of string 650 is displayed on the display screen 600. On the vertical direction of the display, Y coordinates of the piece of string 650 do not overlap with the Y coordinates of the piece of string 610.

The piece of string 610/pendulum 615 and string 650/pendulum 655 move in a way similar to their counterparts described in the first embodiment. Accordingly, detailed description is omitted.

Referring to FIG. 6B, a user uses a finger(s) or other means to make a contact and make a continuous moving path 63 on the touch-sensitive screen. If the continuous moving path 63 has passed through string 610, and the moving acceleration of the contact has exceeded a preset value, the piece of string 610 is separated, by the continuous moving path 63 (shown as a dotted line), into two parts: a stationary part 610a and a disassociated part 610b. The stationary part 610a is displayed as being attached to the upper edge of the display 600 and the disassociated part 610b is displayed as being linked to the pendulum 615. On the display 30, the stationary part 610a and the disassociated part 610b are separated, wherein the stationary part 610a swings according to the pre-determined physical principles, and the disassociated part 610b, together with the pendulum 615, are displayed as departing from the stationary part 610a and falling downward.

When the pendulum 615 is displayed as falling downward and moving beyond the display range of the display 600, the mobile phone switches from the user-interface lock state into a work state. The display screen under the work state is shown in FIG. 3F.

In addition, if the continuous moving path 63 has passed through string 610, but the moving acceleration of the contact has not exceeded the preset value, the piece of string 610 is displayed as moving, together with the pendulum 615, according to the pre-determined physical principles, without being cut off by the continuous moving path 63.

Referring to FIG. 6C, a user uses a finger(s) or other means to make a contact and make a continuous moving path 63 on the touch-sensitive screen. If the continuous moving path 63 has passed through the string 650, and moving acceleration of the contact has exceeded a preset value, the piece of string 650 is separated, by the continuous moving path 63 (shown as a dotted line), into two parts: a stationary part 650a and a disassociated part 650b. The stationary part 650a is displayed as being attached to the stationary base 65 and the disassociated part 650b is displayed as being linked to the pendulum 655. On the display 600, the stationary part 650a and the disassociated part 650b are separated, wherein the stationary part 650a swings according to the pre-determined physical principles, and the disassociated part 650b, together with the pendulum 655, are displayed as departing from the stationary part 650a and falling downward.

When the pendulum 655 is displayed as falling downward and moving beyond the display range of the display 600, the mobile phone switches from the user-interface lock state into an execution state for operation of the application program.

Referring to FIGS. 7A˜7C, in another exemplary embodiment, the electronic device is a mobile phone, and the first and third objects are pieces of string, and the second and fourth objects are floating objects (such as balloons) fastened to the pieces of strings, respectively.

As shown in FIG. 7A, while the mobile phone is in a user-interface lock state, a piece of string 710 (first object) and a balloon 715 (second object) fastened to the piece of string 710, as well as a piece of string 750 (second object) linked to a stationary base 75 and a balloon 755 (fourth object) fastened to the piece of string 750, are displayed on the display 700. In addition, on the vertical direction of the display, Y coordinates of the third object, do not overlap with the Y coordinates of the first object.

In this embodiment, the display of the piece of string 710/balloon 715 and string 750/balloon 755 move in a way similar to their counterparts described in the first embodiment. Accordingly, detailed description is omitted.

As shown in FIG. 7B, a user uses a finger(s) or other means to make a contact and make a continuous moving path 73 on the touch-sensitive screen. If the continuous moving path 73 has passed through the string 710, and the moving acceleration of the contact has exceeded a preset value, the piece of string 710 is separated, by the continuous moving path 73 (shown as a dotted line), into two parts: a stationary part 710a and a disassociated part 710b. The stationary part 710a is displayed as being attached to the lower edge of the display 700 and the disassociated part 710b is displayed as being linked to the balloon 715. On the display 700, the stationary part 710a and the disassociated part 710b are separated, wherein the disassociated part 710b, together with the balloon 715, are displayed as being detached and floating away. When the balloon 715 is displayed as floating away and moving beyond the display range of the display 700, the mobile phone switches from the user-interface lock state into a work state.

Similarly, if the continuous moving path 73 has passed through string 710, but the moving acceleration of the contact has not exceeded the preset value, the piece of string 710 is displayed as moving, together with the balloon 715, according to the pre-determined physical principles, without being cut off by the continuous moving path 73.

As shown in FIG. 7C, a user uses a finger(s) or other means to make a contact and make a continuous moving path 73 on the touch-sensitive screen. If the continuous moving path 73 has passed through string 750, and the moving acceleration of the contact has exceeded a preset value, the piece of string 750 is separated, by the continuous moving path 73 (shown as a dotted line), into two parts: a stationary part 750a and a disassociated part 750b. The stationary part 750a is displayed as being attached to the stationary base and the disassociated part 750b is displayed as being linked to the balloon 755. On the display 700, the stationary part 750a and the disassociated part 750b are separated, wherein the disassociated part 750b, together with the balloon 755, are displayed as being detached and floating away. When the balloon 755 is displayed as floating away and moving beyond the display range of the display 700, the mobile phone switches from the user-interface lock state into an execution state for operation of the application program.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for controlling an electronic device with a touch-sensitive screen, comprising:
while the electronic device is in a user-interface lock state, displaying a first object and a second object corresponding to an unlock operation on the touch-sensitive screen, wherein the first object links to an edge of a display of the touch-sensitive screen, and the second object links to the first object, rather than linking to any edge of the display;
detecting a contact with the touch-sensitive screen, while the electronic device is in the user-interface lock state;
in response to the detected contact on the touch-sensitive screen, determining whether a continuous moving path corresponding to the contact has passed through the first object, and determining whether a moving acceleration of the contact has exceeded a preset value;
when the continuous moving path corresponding to the contact has passed through the first object, and the moving acceleration of the contact has exceeded the preset value, separating the displayed first object into a first stationary part and a first disassociated part, wherein the first stationary part is linked to the edge of the display, and the first disassociated part is linked to the second object, and the first disassociated part is displayed as being severed from the first stationary part and moving away, along with the second object, from the first stationary part according to pre-determined physical principles; and
controlling the electronic device to switch from the user-interface lock state into a work state.

2. The method of claim 1, further comprising:
when the continuous moving path corresponding to the contact has passed through the first object, and the moving acceleration of the contact has not exceeded the preset value, displaying the first object and the second object as moving according to the pre-determined physical principles, without displaying the first object as being separated by the continuous moving path.

3. The method of claim 1, wherein:
the edge linked to the first object is an upper edge of the display;
the first object is a piece of string, wherein the second object is a hanging object suspended from the piece of string; and
when the continuous moving path corresponding to the contact has passed through the piece of string, and the moving acceleration of the contact has exceeded the preset value, the piece of string as being cut off by the continuous moving path, and the first disassociated part of the piece of string is severed from the first stationary part, and the first disassociated part and the hanging object moves away from the first stationary part according to pre-determined physical principles.

4. The method of claim 1, wherein:
the edge linked to the first object as a lower edge of the display;
the first object is a piece of string, wherein the second object is a floating object fastened to the piece of string; and
when the continuous moving path corresponding to the contact has passed through the piece of string, and the moving acceleration of the contact has exceeded the preset value, the piece of string as being cut off by the continuous moving path, and the first disassociated part of the piece of string is severed from first stationary part, and the first disassociated part and the floating object moves away from the first stationary part according to pre-determined physical principles.

5. The method of claim 1, further comprising:
displaying a third object and a fourth object corresponding to initiation of an operation for an application program on the touch-sensitive screen, wherein the third object links to a stationary object, and the fourth object links to the third object, rather than linking to the stationary object or any edge of the display, and, on the vertical direction of the display, Y coordinates of the third object, do not overlap with the Y coordinates of the first object;
determining whether the continuous moving path corresponding to the contact has passed through the third object, and determining whether a moving acceleration of the contact has exceeded the preset value;
when the continuous moving path corresponding to the contact has passed through the third object, and the moving acceleration of the contact has exceeded the preset value, separating the displayed third object as a third stationary part and a third disassociated part, wherein the third stationary part is linked to the stationary object, and the third disassociated part is linked to the fourth object, and the third disassociated part is displayed as being severed from the third stationary part and moving away, along with the fourth object, from the third stationary part according to pre-determined physical principles; and
controlling the electronic device to be switched from the user-interface lock state into an execution state for operation of the application program.

6. The method of claim 5, further comprising:
when the continuous moving path corresponding to the contact has passed through the third object, and the moving acceleration of the contact has not exceeded the preset value, displaying the third object and the fourth object as moving according to the pre-determined physical principles, without displaying the third object as being separated by the continuous moving path.

7. The method of claim 5, wherein:
the third object is a piece of string, and the fourth object is a hanging object suspended from the piece of string; and
when the continuous moving path corresponding to the contact has passed through the piece of string, and the moving acceleration of the contact has exceeded the preset value, the piece of string as being cut off by the continuous moving path, the third disassociated part of the piece of string is severed from the third stationary part, and the third disassociated part and the hanging object moves away from the third stationary part according to pre-determined physical principles.

8. The method of claim 5, wherein:
the third object is a piece of string, and the fourth object is a floating object fastened to the piece of string; and
when the continuous moving path corresponding to the contact has passed through the piece of string, and the moving acceleration of the contact has exceeded the preset value, the piece of string as being cut off by the continuous moving path, the third disassociated part of the piece of string is severed from third stationary part, and the third disassociated part and the floating object moves away from the third stationary part according to pre-determined physical principles.

9. An electronic device, comprising:
a touch-sensitive screen, comprising a display and receiving contact inputs, wherein the display displays a first object and a second object corresponding to an unlock operation, wherein the first object links to an edge of the display, and the second object links to the first object, rather than linking to any edge of the display; and
a controller, detecting a contact with the touch-sensitive screen, while the electronic device is in the user-interface lock state, and in response to the detected contact on the touch-sensitive screen, determining whether a continuous moving path corresponding to the contact has passed through the first object, and determining whether a moving acceleration of the contact has exceeded a preset value, and when the continuous moving path corresponding to the contact has passed through the first object, and the moving acceleration of the contact has exceeded the preset value, causing the touch-sensitive screen to separate the displayed first object into a first stationary part and a first disassociated part, wherein the first stationary part is linked to the edge of the display, and the first disassociated part is linked to the second object, and the first disassociated part is displayed as being severed from the first stationary part and moving away, along with the second object, from the first stationary part according to pre-determined physical principles, and controlling the electronic device to switch from the user-interface lock state into a work state.

10. The electronic device of claim 9, wherein:
when the continuous moving path corresponding to the contact has passed through the first object, and the moving acceleration of the contact has not exceeded the preset value, the controller further causes the display to display the first object and the second object as moving according to the pre-determined physical principles, without displaying the first object as being separated by the continuous moving path.

11. The electronic device of claim 9, wherein:
the display displays the first object as being linked to an upper edge of the display, and displays the first object as being a piece of string, wherein the second object is displayed as being a hanging object suspended from the piece of string;
the controller, when the continuous moving path corresponding to the contact has passed through the piece of string, and the moving acceleration of the contact has exceeded the preset value, causes the touch-sensitive screen displays the piece of string as being cut off by the continuous moving path, and the first disassociated part of the piece of string is severed from the first stationary part, and the first disassociated part and the hanging object moves away from the first stationary part according to pre-determined physical principles.

12. The electronic device of claim 9, wherein:
the touch-sensitive screen displays the edge linked to the first object as a lower edge of the display, and the first object is a piece of string, wherein the second object is a floating object fastened to the piece of string;
the controller, when the continuous moving path corresponding to the contact has passed through the piece of string, and the moving acceleration of the contact has exceeded the preset value, causes the touch-sensitive screen to display the piece of string as being cut off by the continuous moving path, and the first disassociated part of the piece of string is severed from first stationary part, and the first disassociated part and the floating object moves away from the first stationary part according to pre-determined physical principles.

13. The electronic device of claim 9, wherein:
the touch-sensitive screen displays a third object and a fourth object corresponding to the initiation of an operation for an application program on the display, wherein the third object links to a stationary object, and the fourth object links to the third object, rather than linking to the stationary object or any edge of the display, and Y coordinates, i.e., on the vertical direction of the display, of the third object, do not overlap with the Y coordinates of the first object;
the controller determines whether the continuous moving path corresponding to the contact has passed through the third object, and determines whether moving acceleration of the contact has exceeded the preset value;
the controller, when the continuous moving path corresponding to the contact has passed through the third object, and the moving acceleration of the contact has exceeded the preset value, causes the touch-sensitive screen to display the displayed third object as being separated from a third stationary part and a third disassociated part, wherein the third stationary part is linked to the stationary object, and the third disassociated part is linked to the fourth object, and the third disassociated part is displayed as being severed from the third stationary part and moving away, along with the fourth object, from the third stationary part according to pre-determined physical principles; and
the controller, controls the electronic device to be switched from the user-interface lock state into an execution state for operation of the application program.

14. The electronic device of claim 13, when the controller determines that the continuous moving path corresponding to the contact has passed through the third object, and the moving acceleration of the contact has not exceeded the preset value, the controller causes the touch-sensitive screen to display the third object and the fourth object as moving according to the pre-determined physical principles, without displaying the third object as being separated by the continuous moving path.

15. The electronic device of claim 13, wherein:
the touch-sensitive screen displays the third object as a piece of string, and displays the fourth object as being a hanging object suspended from the piece of string;
when the controller determines that the continuous moving path corresponding to the contact has passed through the piece of string, and the moving acceleration of the contact has exceeded the preset value, the touch-sensitive screen displays the piece of string as being cut off by the continuous moving path, the third disassociated part of the piece of string as being severed from the third stationary part, and the third disassociated part and the hanging object as moving away from the third stationary part according to pre-determined physical principles.

16. The electronic device of claim 13, wherein:
the touch-sensitive screen displays the third object as a piece of string, and the fourth object as a floating object fastened to the piece of string;
when the controller determines that the continuous moving path corresponding to the contact has passed through the piece of string, and the moving acceleration of the contact has exceeded the preset value, the touch-sensitive screen displays the piece of string as being cut off by the continuous moving path, the third disassociated part of the piece of string as being severed from third stationary part, and the third disassociated part and the floating object as moving away from the third stationary part according to pre-determined physical principles.
